(19) United States
(12) Patent Application Publication
(10) Pub. No.: US 2011/0131074 A1
(43) Pub. Date: Jun. 2, 2011

(54) MAINTENANCE CONTROL SYSTEM

(76) Inventors: David S Gilleland, Charlotte, NC (US); Rob Satchwell Tennant, Matthews, NC (US); Michael Layton Gregory, Clover, SC (US); Pieter Erasmus, Boksburg North (ZA)

(21) Appl. No.: 12/889,493

(22) Filed: Sep. 24, 2010

Related U.S. Application Data
(63) Continuation-in-part of application No. PCT/US2009/005463, filed on Oct. 5, 2009.
(60) Provisional application No. 61/245,500, filed on Sep. 24, 2009.
(60) Provisional application No. 61/257,313, filed on Nov. 2, 2009.

(30) Foreign Application Priority Data
Aug. 4, 2010 (GB) GB1013127.4
Aug. 4, 2010 (GB) GB1013128.2
Aug. 4, 2010 (GB) GB1013129.0
Aug. 4, 2010 (GB) GB1013130.8
Aug. 4, 2010 (GB) GB1013131.6

(51) Int. Cl. G06Q 10/00

(52) U.S. Cl. 705/7.15

(57) ABSTRACT

A maintenance control system monitors maintenance requirements in a plurality of vehicles to enable a processor to determine a maintenance requirement of a first asset and to select a maintenance action for a second asset based on the maintenance requirement of the first asset.

### CROSS REFERENCES TO RELATED APPLICATIONS

This application is a continuation-in-part of International Application No. PCT/US2009/005463, filed Oct. 5, 2009, which claims the benefit of U.S. Provisional Application No. 61/245,500, filed Sep. 24, 2009, the entire disclosures of which are hereby incorporated by reference. This application also claims the benefit of U.S. Provisional Application No. 61/257,313, filed Nov. 2, 2009, the entire disclosure of which is hereby incorporated by reference.

This application also claims the benefit of the following applications: GB Application No. 1013129.0, filed Aug. 4, 2010, GB Application No. 1013128.2, filed Aug. 4, 2010, GB Application No. 1013127.4, filed Aug. 4, 2010, GB Application No. 1013130.8, filed Aug. 4, 2010, and GB Application No. 1013131.6, filed Aug. 4, 2010, the entire disclosures of which are hereby incorporated by reference.

### BACKGROUND OF THE INVENTION

The present invention relates to maintenance monitoring of vehicles, particularly fleet vehicles, and in a particular embodiment to maintenance monitoring for plant, lift truck and materials handling equipment.

It is known to monitor the performance and maintenance needs of individual vehicles and to schedule servicing and maintenance based on the needs of a vehicle. It is a problem for operators of fleets of vehicles that multiple vehicles must be maintained in multiple sites or facilities in geographically separated locations. Vehicles in a fleet will typically have different operating requirements and be subject to different operational loads. This means that the maintenance needs of each vehicle in a fleet in any given location will not necessarily coincide. Ill maintained vehicles may perform less efficiently or have shorter life. However, monitoring individual vehicles and attending to maintenance needs of each vehicle in a fleet based on the particular needs of that individual vehicle may have unacceptable environmental impact when applied to multiple vehicles arranged in geographically distant locations. Thus there exists a need in the art to maintain and monitor fleet vehicles in a manner which reduces the carbon cost and environmental impact of such maintenance and/or preserves the efficiency of operation of vehicles within the fleet.

The threat of climate change and the need to reduce the environmental impact of industry are both well known. Thus there exists a general need in the art to reduce the energy/carbon cost associated with operating fleets of vehicles.

Aspects and examples of the invention are set out in the claims and provide methods, apparatus and systems which address at least some of the above-described technical problem.

In an aspect there is provided a monitoring station comprising a communication interface for communication with a plurality of monitoring devices, each device arranged to monitor an operational parameter of a mobile asset and a processor coupled to the communication interface to receive a first operational parameter associated with a first asset and a second operational parameter associated with a second asset wherein the processor is configured to determine a maintenance requirement of the first asset based on the first operational parameter and to select a maintenance action for the second asset based on the maintenance requirement of the first asset and the second operational parameter. This has the advantage that maintenance needs can be anticipated and/or grouped and dealt with in an energy efficient manner.

In one possibility an operational parameter is derived from a CANBUS of the asset. This has the advantage that monitoring can be based on existing vehicle systems without the need for additional measurement interfaces.

In one possibility a monitoring station comprises a memory for storing a list of identifiers, each identifier associated with a monitoring device and wherein each identifier indicates a type of asset. This has the advantage that maintenance needs can be identified based the type of asset. For example, in one possibility a memory stores a look up table for each type of asset and each lookup table stores an association between a range or ranges of operational parameters and a maintenance action for that type of asset.

In one possibility selecting a maintenance action for the second asset comprises scheduling a maintenance action based on the maintenance requirement of the first asset and the geographical proximity of the first and second assets. For example when one asset indicates an immediate need for maintenance, one or more other assets nearby which are likely to require maintenance within a defined period (for example the next week or the next month) based on their operational parameters or predicted issues based on identical issues in other assets may be identified or scheduled for maintenance. This and other examples have the advantage that the overall distance which must be travelled to perform maintenance actions can be reduced.

In an aspect there is provided a method of scheduling maintenance of a plurality of assets at a respective asset location, from a remote monitoring system, the method comprising receiving operational parameters from the plurality of assets at the remote monitoring system, wherein the operational parameters comprise an asset identifier and position information; and determining a likely maintenance action based on the operational parameters; and scheduling a maintenance action for one of the plurality of assets based on operational parameters associated with at least one other asset of the plurality of assets.

For example a likely maintenance action can include actual repair of an asset or preventive maintenance, for example to prevent a predicted component failure. Preferably a measure of asset location is derived from the operational parameters, this can be performed by inferring location information from the communication link (e.g. using the senders IP address, GSM mobile number or other communication identifier such as email address) and making a comparison with stored location information associated with that communication link. This may be implemented by storing communication link and location information in a database. Alternatively location information can be derived from an asset identifier of the operational parameters, for example a database may store an association between asset identifiers and locations. In one possibility received information comprises actual location information such as a street address, a map grid reference, location name i.e. a site identifier recognisable by a human operator (such as an abbreviated name, company code, or colloquial name for a location), or GPS co-ordinates or any other location information.

Where an asset is a mobile asset, such as a warehouse vehicle or a forklift truck or reach truck communication may take place wirelessly between one or more of the plurality of assets and the remote monitoring station, alternatively wireless communication may be relayed to the remote monitoring system between one or more intermediate communications devices such as a router, wireless hub, GSM or GPRS modem or other communication device. Therefore receiving operational parameters from the plurality of assets at the remote monitoring system may comprise one or more intermediate communication steps, or may be direct.

Typically, where location information is to be inferred based on a vehicle identifier there is a need to update stored location information and/or associations between vehicle/asset identifiers and location information. Either periodically, intermittently or in response to an operator action a vehicle identifier is communicated by the vehicle for to a remote monitoring system updating a stored association between asset identifiers and locations. Alternatively when an asset/vehicle communicates with a remote monitoring system (or an intermediate hub or installation) the asset/vehicle identifier information is compared with a stored list of identifiers associated with that location and, in the event that it is determined that that vehicle identifier is associated with another location, the stored association is updated. Preferably, by this method, inventories of assets vehicles are updated without the need for manual surveys of which assets/vehicles are present in which locations.

Operational parameters can be used to indicate that an asset, such as a vehicle, requires repair and continuing to operate the vehicle without repair is associated with a reduced energy efficiency. If the energy cost associated with the maintenance action is less than the energy lost to inefficiency then the maintenance action is scheduled, for example to take place immediately, at the time of the next periodic maintenance visit or as soon as practicable.

Particular examples of the invention communicate CANBUS information to enable the lifetime or maintenance requirements of vehicle components to be predicted. In an example a facility monitoring system is arranged to collate predicted maintenance tasks for each of a plurality of vehicles to determine which vehicles will/may need to be serviced and when such action is most probable. Probability of a required maintenance action for each vehicle can be estimated based on CANBUS information and/or event information.

In an aspect there is provided a monitoring and reporting device for use in a mobile asset comprising: a measurement interface for measuring operational parameters of a mobile asset and a buffer coupled to the measurement interface for storing measured operational parameters; and a communication interface for receiving commands from a remote monitoring system and a processor configured to store measured operational parameters in the buffer in response to a received command. Typically the measurement interface includes a CANBUS interface and, for example, operational parameters include parameters derived from a CANBUS message wherein the processor is configurable by a remote command to store selected CANBUS messages for storage. Optionally CANBUS messages are selected based on a message type identifier and, in some examples the processor is configured to transmit the contents of the buffer using the communication interface when the buffer is full.

To operate in environments where communication is difficult and/or intermittently available the processor can be configured to determine whether the communication interface is able to communicate with a remote monitoring station. For improved reliability the processor can be configured to store data from the buffer into a non-volatile memory in the event that it is determined that the communication interface is not able to communicate with a remote monitoring station. To ensure timely reporting of data in a hostile communication environment the processor can be configured to test periodically, or at intervals, whether the communication interface is able to communicate with a remote monitoring station. In some examples, to save power the processor is coupled to a user actuable switch and is configured to test whether the communication interface is able to communicate with a remote monitoring station in response to actuation of the switch.

In certain environments there are known “sweet spots” for communication where a wireless communication link is generally reliable. Therefore a location determiner can be coupled to the processor and so that the processor can be configured to test whether the communication interface is able to communicate with a remote monitoring station in response to the location determiner indicating that the device is in a selected location. A location determiner may include a position monitoring system as described elsewhere herein.

In one example a software application is provided to correlate probability of required maintenance across each of a plurality of vehicles within a fleet and, for example, across a plurality of such fleets held at separate locations to determine a schedule of maintenance actions based on one or more criteria. Criteria may include optimising an energy cost, optimising the energy cost of maintenance, optimising the financial cost of maintenance, ensuring sufficient vehicles/assets to meet operational need remain in working order. In other words, if the volume of work through a warehouse is low one or more assets may remain unrepaired without adversely affecting operation of the warehouse. In other circumstances all vehicles must be maintained at all times or additional vehicles may be required.

Where maintenance actions are required for a vehicle, typically there will be some inefficiency in operation of that vehicle which will increase over time, and, in a fleet of vehicles this effective may be cumulative. Therefore, in one possibility scheduling a maintenance action for one of the plurality of assets based on the aggregated performance information comprises determining the energy cost of the maintenance action and determining the energy saving associated with the maintenance action and postponing the scheduled maintenance action if the overall energy cost associated with the maintenance action is less than the energy cost of vehicle inefficiency. When the cumulative loss of energy due to cumulative inefficiency of the vehicle fleet is greater than or equal to the energy cost of maintenance actions those actions should be performed. Advantageously this method reduces the energy cost of maintaining a fleet of vehicles at a location remote from a maintenance facility.

Method embodiments account for the reduced efficiency of running a vehicle in need of maintenance and taken into account the energy cost associated with repeated maintenance visits to a site. In preferred aspects and examples of the invention improved safety of operation is provided by maintenance based upon vehicle monitoring.

Preferred examples of this method comprise predicting a maintenance action based on one or more performance indicators associated with an asset. Performance indicators may include CANBUS information, performance information, diagnostic information, fault code occurrence, fault code frequency. The above described advantages can be further increased by scheduling maintenance actions based on a predicted maintenance action. For example if it is known that a maintenance action is imminent it can be attended to during regular scheduled maintenance associated with other vehicles and/or assets or it can be attended to at the same time as other ad-hoc or periodic maintenance visits.

In an example a second plurality of assets are provided at a second asset location wherein the first and second locations are associated with a respective one of a first and second location indicator such that each maintenance action is associated with a location indicator. In some examples a plurality of such asset locations are provided each associated with a corresponding location indicator. Advantageously embodiments having more than one asset location provide further aggregate reductions in energy consumption (compared with such separate facilities maintained according to prior art methods) by permitting a travelling salesman optimisation which optimises a maintenance energy cost function dependent on required actions, the location associated with each action, and resources locations and priority

Particular resources at a second resource location may be obtained during other maintenance journeys for predicted maintenance or based on resource indicators such as the availability of the required spare parts and technicians having the required skills. In addition to the constraints of operational need and energy cost outlined above the availability of spare parts may alter the maintenance schedule. Therefore, in a preferred embodiment scheduling maintenance actions for one of the plurality of assets based on operational parameters associated with at least one other asset of the plurality of assets comprises scheduling based on at least one of: a spare parts inventory, an energy cost, operational need and/or usage requirements; and availability of a skilled technician.

As will be appreciated (and as is described below with reference to critical and non critical performance indicators) different maintenance actions are of differing priority. Preferably therefore it is possible to assign priority to maintenance actions, and schedule maintenance actions based on priority and location. Maintenance requests which originate from the same or associated locations can be grouped and alternatively maintenance requests can be grouped by resource indicator and location.

In an example CANBUS information is downloaded to a remote monitoring facility in advance of scheduled maintenance, in response to a trigger or to determine a maintenance need based on a prediction or indicative information derived from monitoring information. In one example diagnostic data for a first vehicle can be downloaded in advance of scheduled maintenance of a second vehicle, or in response to a trigger generated by a second vehicle, for example need based on a prediction or indicative information derived from monitoring information of the second vehicle. Advantageously this permits maintenance actions for the first vehicle to be determined in response to another maintenance need. This can provide improved efficiency, help to diagnose problems before they occur and reduce the number of maintenance visits (and hence energy consumption) that would otherwise be required. In one example the CANBUS information selected to be downloaded is based on performance score for components (or an overall performance score) as described in greater detail below. The trigger for downloading information from a vehicle CANBUS may be the occurrence of a fault in another vehicle, optionally CANBUS download from a first vehicle is modified in response to CANBUS information from a second vehicle.

In one aspect there is provided a location monitoring system comprising a plurality of radio frequency transponders and a mobile radio frequency transceiver operable to receive a unique identifier from each of the plurality of RFID tags; and a memory storing an association between each of a plurality of unique identifiers and each of a plurality of location identifiers; and a controller arranged to compare an identifier read from one of the plurality of RFID tags with the stored associations to determine a location.

In one example the mobile radio frequency transceiver is attached to a mobile asset such as a forklift truck and typically the radio frequency transponders are passive RFID tags and the mobile radio frequency transceiver is an RFID reader. This provides a system which does not require wiring, or multiple power supplies or wireless communication with the truck. The truck carrying a reader can simply read a unique identifier from a tag in its proximity and determine its location using the stored associations.

In an aspect transceivers are distributed throughout a facility at known locations and mobile assets within the facility are provided with radio frequency transponders. In examples the transceivers can be battery powered and are arranged to be triggered when a mobile asset comes into range of the transceivers. Transceivers can be triggered by a mechanical actuator such as a pressure pad or switch or by a low power proximity detector such as a PIR sensor. Advantageously this permits the transceivers to be battery powered and reduces the frequency with which batteries must be replaces.

Derived location information can be communicated to systems associated with a mobile asset such as vehicle power controllers such as those described herein with reference to FIGS. 6, 7 , 8 and 9 or authorisation control systems such as those described herein with reference to FIGS. 1 to 3.

In one aspect there is provided a positioning system for determining the location of a mobile asset in a facility, the system comprising:

a plurality of machine readable identifiers positioned about the facility; and

a memory storing an association between one or more positions in the facility and one or each of the plurality of identifiers; and

a mobile asset having a proximity reader for reading a machine readable identifier of the plurality of machine readable identifiers in reading range of the reader; and a processor, in communication with the reader and the processor arranged to determine a position of the mobile asset based on the stored association.

In one possibility the facility is a warehouse and in another possibility the facility is a dock, a freight terminal or an airport. Preferably the machine readable identifiers are positioned with a separation of at least five times the reading range of the reader. This provides a system which reliably reports a unique location without the need for complex positioning equipment. Alternatively or additionally the reader is provided with a directional antenna.

In one possibility the mobile asset comprises logic for comparing an identifier with a stored association to determine a position of the mobile asset based on the stored association. Advantageously this permits a mobile asset to obtain position information without communicating with any remote system. In one possibility the logic is configured to set idle time intervals and/or record operational parameters and/or send operational parameters to a remote system in response to determining that the mobile asset is in a particular position (such as in one of the zones described below).

In an aspect there is provided a warehouse vehicle comprising a proximity reader for reading a machine readable identifier; and a memory storing an association between each of a plurality of identifiers and one or more positions; and comparison logic arranged to compare an identifier with a stored association to determine a position, for example in response to the proximity reader reading a machine readable identifier.

In an aspect there is provided a warehouse comprising a plurality of machine readable markers each marker associated with a location; and one or more warehouse vehicles comprising a proximity reader for reading the machine readable markers; and comparison logic for comparing information read from the markers with a stored association to determine a location of the vehicle.

In one possibility there is provided a warehouse wherein the one or more warehouse vehicles comprises a communication interface for communicating with the comparison logic. In one possibility the warehouse comprises a monitoring station operable to communicate wirelessly with the vehicle via the communication interface wherein the remote monitoring station comprises the comparison logic. Preferably the comparison logic is attached to the vehicle so that location information can be determined where immediate communication with the remote monitoring station is not available.

Typically a mobile asset comprises a communication interface for communication with a remote monitoring station, in these examples the remote monitoring station comprises the memory and a remote logic for determining the position of the mobile asset based on the stored association.

In an example a mobile asset is a warehouse vehicle such as a fork lift truck or other vehicle. The machine readable identifiers can comprise RFID tags, machine readable barcodes, two dimensional bar codes, tuned resonators such as those used in electronic article surveillance theft detection systems (e.g. LCR tank circuit coupled to an antenna), machine recognisable symbols such as shapes or numbers or non numeric markings or other capacitive, inductive or electronic marking systems. Whatever machine readable marking system is provided a corresponding proximity reader is provided, for example a proximity reader may comprise a broad band RF transceiver, a near field RF communicator (such as an RFID reader) or a digital video camera coupled to digital image recognition software for identifying symbols such as shapes or numbers or non numeric markings Alternatively capacitive or inductive proximity readers are provided for reading the machine readable identifiers.

Typically in a warehouse environment a stored association comprises an association between one or more (or a group) of machine readable identifiers and a zone of the warehouse such as a particular aisle between storage units, or an area of a zone adjacent a particular storage unit, a waiting zone, an unloading zone (for goods leaving the warehouse) and a delivery zone (for goods being delivered to the warehouse). The zones selected for each example of a warehouse positioning system will vary dependent on operational need and the particular circumstances of each example. Alternatively a stored association may comprise an association between the absolute position (i.e. the GPS co-ordinates or map grid reference), or relative position (i.e. distance from selected reference points) and each machine readable identifier.

Memory may be provided in each mobile asset so that in response to the proximity reader reading an identifier, logic in the mobile asset can determine position information based on the stored association. In one possibility the memory is provided in a remote location (such as a location comprising a remote monitoring system or a communications relay such as a wireless hub or router) and identifier information read by the proximity reader is communicated to the logic in the remote location so that position information for the mobile asset can be determined based on the stored association and, as appropriate, the vehicle identifier.

In one example machine readable identifiers comprise passive RFID tags which may be ruggedised to withstand high pressures and/or impacts. Preferably ruggedised RFID tags are affixed to flooring of a warehouse and are potted in a shield structure comprising resilient and materials to protect the tag from being crushed. Preferably a ruggedised RFID tag is able to withstand compressive forces of between 7000N and 70000N and so can withstand the weight of most un-laden forklift trucks. Still more preferably a ruggedised RFID tag is embedded in a protective shield and is able to withstand compressive forces of 70 kN, still more preferably 700 kN.

In one method aspect the invention provides a calibration method for a warehouse positioning system the method comprising positioning machine readable identifiers throughout a warehouse and storing an association between each identifier and position information to enable operation of a warehouse positioning system according to other aspects of the invention.

In a method aspect there is provided a method of configuring a location monitoring system, the method comprising providing a position reference communicator at each of at least three known locations; and disposing at a first location a machine readable identifier and determining the first location based on communication with at least three of the at least three position reference communicators and storing in a memory an association between the identifier and the first location. In an example a machine readable identifier comprises a passive RFID tag or a two dimensional barcode.

In preferred examples an association can be stored for each of a plurality of locations. In one possibility an association is stored for each of at least 50 locations. Stored associations between identifiers and locations can be downloaded to a second memory for use in a mobile asset. The advantage of this procedure is that complex and accurate triangulation can be performed once in a “calibration step” subsequently no complicated processing or calculation is required and only simple equipment (i.e. an RFID reader and a memory) is needed to determine a position. The accuracy of this method is of course dependent on the triangulation method used and the communication range of the radio frequency transponders. In an alternative, machine readable identifiers may simply be resonant tank circuits tuned to a particular frequency, these may be read by a broad band transceiver so that rather than being identified by a numeric identifier each tag can be associated with a particular frequency, associations can then be stored between transponder frequency and location.

An identifier may be a unique identifier or may be associated with a set of tags. Alternatively a set of identifiers may be associated with one location or zone. Preferably an identifier is associated with a set of tags for example which may be used to indicate a zone or area of a facility such as a warehouse or a parking area.

In one possibility a vehicle has an interface device having a control bus over which vehicle parameters are passed comprising a vehicle interface for communicating with a control bus of the vehicle; a wireless interface for communicating data packets with a remote server; buffer memory for storing packets to send over the wireless interface; and a processor for controlling communication, wherein the processor is arranged to detect whether wireless interface is available for live transmission to the server and to select information for transmission or buffering based on availability.

In one possibility the interface device has further memory for storing information separate from the buffer, wherein the processor is arranged to respond to a query received over the interface to transmit information stored in the further memory on request.

In one possibility the device comprises an operator communication interface arranged to store operator input received when the interface is not available for transmission at a time the wireless interface is available.

In one possibility the wireless interface is a telecommunications interface having a data transmission protocol and a text message protocol wherein the apparatus is arranged to format data into messages suitable for transmission by the text message protocol in the event the data transmission protocol is unavailable.

In one possibility the processor is arranged to communicate operator information bi-directionally with an operator console or operator application.

Optionally there is provided a server for communicating with a plurality of remote vehicles each having an interface device as set out herein above comprising a vehicle data memory for storing vehicle information received from a plurality of vehicles and operator information memory for storing operator information received or messages for transmission to the operator.

In one possibility the server is arranged to make the vehicle data memory available to a first application and the operator information memory available to a second application.

In one possibility there is provided a method of operating a control bus over which vehicle parameters are passed, the method comprising communicating with a control bus of the vehicle using a vehicle interface; and communicating data packets with a remote server over a wireless interface; storing packets to send over the wireless interface in a buffer memory; and detecting whether a wireless interface is available for live transmission to the server and selecting information for transmission or buffering based on availability of the wireless interface.

In one possibility the method of operating a control bus comprises storing information in a further memory separate from the buffer, and responding to a query received over the interface to transmit information stored in the further memory on request.

In one possibility the method of operating a control bus comprises storing operator input received when the wireless interface is not available for transmission at a time the wireless interface is available.

In one possibility the wireless interface is a telecommunications interface having a data transmission protocol and a text message protocol, the method comprising formatting data into messages suitable for transmission by the text message protocol in the event the data transmission protocol is unavailable.

Optionally the method comprises communicating operator information bi-directionally with an operator console or operator application.

In one possibility the method comprises verifying operator information based on information read from a removable rewritable token.

There is described herein a positioning system for determining the location of a mobile asset in a facility, the system comprising:

a plurality of machine readable identifiers positioned about the facility; and

a memory storing an association between one or more positions in the facility and one or each of the plurality of identifiers; and

a mobile asset having a proximity reader for reading a machine readable identifier of the plurality of machine readable identifiers in a reading range of the reader; and

a processor, in communication with the reader and the processor arranged to determine a position of the mobile asset based on the stored association.

In a possibility the mobile asset comprises logic for comparing an identifier with a stored association to determine a position of the mobile asset based on the stored association.

In a possibility the machine readable identifiers are positioned with a separation of at least five times the reading range of the reader.

There is described a warehouse vehicle comprising a proximity reader for reading a machine readable identifier; and a memory storing an association between each of a plurality of identifiers and one or more positions; and comparison logic arranged to compare an identifier with a stored association to determine a position.

In a possibility the comparison logic is configured to compare an identifier with a stored association in response to the proximity reader reading a machine readable identifier.

In a possibility wherein the proximity reader is a near field RF communicator.

Described herein is a warehouse comprising a plurality of machine readable markers each marker associated with a location; and one or more warehouse vehicles comprising a proximity reader for reading the machine readable markers; and comparison logic for comparing information read from the markers with a stored association to determine a location of the vehicle.

Described is a server for communicating with a plurality of remote vehicles each having an interface device according to this disclosure comprising vehicle data memory for storing vehicle information received from a plurality of vehicles and operator information memory for storing operator information received or messages for transmission to the operator. Optionally the service is arranged to make the vehicle data memory available to a first application and the operator information memory available to a second application.

As will be appreciated, features from any one method aspect may be implemented in combination with all or some of the features of another method aspect and features of any described method embodiment may be employed in combination with all or some of the features of any other method embodiment. Equally features described with reference to performance of a method also extend to (but do not require) specific hardware adapted to support that method.

### BRIEF SUMMARY

A maintenance control system monitors maintenance requirements in a plurality of vehicles to enable a processor to determine a maintenance requirement of a first asset and to select a maintenance action for a second asset based on the maintenance requirement of the first asset.

One object of the present disclosure is to describe an improved maintenance control system for monitoring a plurality of vehicles.

### BRIEF DESCRIPTION OF THE SEVERAL VIEWS OF THE DRAWINGS

FIG. 1 depicts an authorisation control unit installed on a vehicle.

FIG. 2 depicts a driver access token coupled to a driver access token update system.

FIG. 3 depicts a warehouse facility having a facility access control and driver access token update system.

FIG. 4 depicts a schematic diagram of vehicle components and a CANBUS vehicle bus.

FIG. 5 shows a schematic representation of a warehouse with a facility control system.

FIG. 6 shows a schematic representation of a programmable vehicle power controller.

FIG. 7 is a schematic flow chart representation of operation of a vehicle power controller.

FIG. 8 is a schematic flow chart representation of a method of configuring a controller according to FIG. 6.

FIG. 9 shows a very schematic representation of a warehouse positioning system.

### DETAILED DESCRIPTION

For the purposes of promoting an understanding of the disclosure, reference will now be made to the embodiments illustrated in the drawings and specific language will be used to describe the same. It will nevertheless be understood that no limitation of the scope of the disclosure is thereby intended, such alterations and further modifications in the illustrated device and its use, and such further applications of the principles of the disclosure as illustrated therein being contemplated as would normally occur to one skilled in the art to which the disclosure relates.

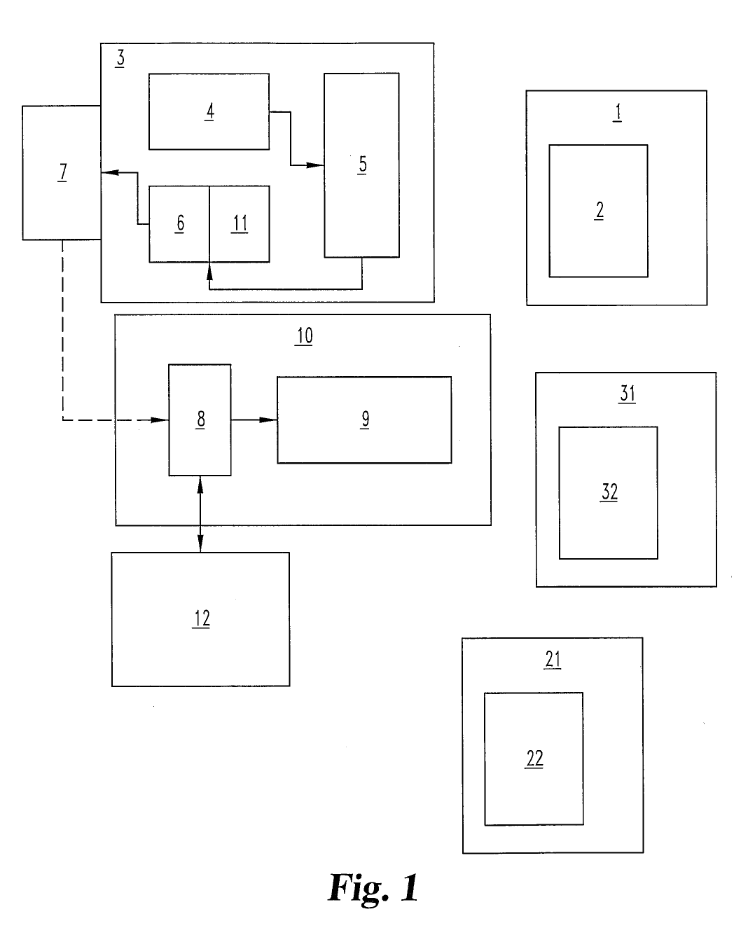

In the example of FIG. 1 an authorisation control unit 3 has vehicle identity logic 4 coupled to a near field RF communication interface 5. The near field RF communication interface 5 is coupled to driver record logic 6 and to enable logic 11 which in turn is coupled to a vehicle interface 7. When the authorisation control unit is mounted on a vehicle 10 the vehicle interface can be coupled to a secure enablement unit 8 coupled to control at least a part of vehicle functionality 21.

Vehicle 10 is a reach truck with an out rigging of telescoping forks that move up and down. The forks are suitable for lifting and manipulating pallets and also include hydraulics that allow the operator to pick up a load and reposition it over the outriggers and allow the forks to position pallets into shelving by sliding the pallet into place. Vehicle 10 may be a stand-up reach model operable to slide forks under the pallet, transport it to the desired storage location, and slide it into place, typically these trucks are used for shelving units that are no deeper than required to place one pallet of goods. Optionally vehicle 10 may be a double deep reach or straddle reach truck that can not only slide under the pallet, but also grab the sides as well. Typically a facility such as a warehouse will make use of all these types of reach truck in addition to other types of materials handling vehicles and other vehicles which may have varying training or license requirements. The present invention is described with particular reference to such vehicles but, as will be appreciated these examples are provided by way of illustration and the invention is not so limited.

A removable rewritable driver token 1 has a memory 2 coupled to a near field RF communication interface for communicating with a near field RF communication interface of an authorisation control unit. Memory 2 stores a unique driver identifier and a list of vehicle identifiers to indicate vehicles the driver is authorised to operate.

The vehicle identity logic 4 includes a memory which stores at least one vehicle identifier and at least one vehicle enable code. Communication interface 5 is arranged to read vehicle identity information from the vehicle identity logic and to read information using near field RF communication from driver tokens 1 in near field range. Typically, in operation, when a communication interface 4 detects a token 1 in near field range it transmits an RF signal which couples inductively with an inductive coupling element of the driver token. Using electric power derived from the inductively coupled RF signal (or using an integrated power supply) the token communicates stored driver authorisation information back to the communication interface 5.

Driver authorisation information comprises a unique driver identifier code and a list of vehicle authorisation codes. As the communication interface reads the driver authorisation information it can communicate the unique driver identifier to the driver record logic. Listed vehicle identifiers are compared with vehicle identity information stored by the vehicle identifier logic. In the event that a listed vehicle identifier matches stored vehicle identity information the enable logic 11 generates an enable signal for the vehicle based on matching the vehicle identifier for the vehicle on which the authorisation control device is installed with one of the vehicle identifiers in the list of authorised vehicles stored in the token. The enable signal may be configured (e.g. coded) only to activate a particular vehicle to prevent unauthorised removal and transfer of authorisation units between vehicles. The driver record logic makes an entry in a non-volatile memory to record a vehicle authorisation and communicates an authorisation signal to the vehicle interface 7. Advantageously the authorisation system is self contained and no real-time communication to an outside system or database is required for authorisation. The device does not require complex logic to determine whether the driver is authorised; instead it simply needs to match its own vehicle identifier with the list stored on the driver token.

In the event that no listed vehicle identifier matches stored vehicle identity information the driver record logic makes an entry in memory to record a failed vehicle authorisation attempt. It is desirable for the authorisation control unit 3 to provide information to a user to indicate a successful or unsuccessful authorisation. Repeated unsuccessful authorisation attempts may trigger a lockout period during which no further authorisation attempts will be accepted. A user indication, typically a red light or low pitch tone may be provided to indicate this status to a user.

In one embodiment, during operation of the vehicle the communication interface communicates periodically or intermittently with the removable rewritable driver token 1 to ensure that the driver token has not been removed. In the event that, after operation of a vehicle has commenced, a secure driver access token is not detected by the communication interface an alert procedure is triggered by enable logic 11. Alternatively the vehicle may be activated for a predetermined period (e.g. a shift period, an interval between prescribed breaks) which may be configurable. An alert procedure may comprise initiating a visible and/or audible alarm signal, gradually reducing the vehicle speed if the vehicle is in motion until the vehicle become stationary, preventing the vehicle from moving if it is stationary, disabling at least one function of the vehicle, recording an event using an event logging buffer and communicating over a wireless communication interface with a remote device to call a supervisor or other authorised operator.

In one possibility there is an interface device for a vehicle having a control bus over which vehicle parameters are passed comprising a vehicle interface for communicating with a control bus of the vehicle; a wireless interface for communicating data packets with a remote server; buffer memory for storing packets to send over the wireless interface; and a processor for controlling communication, wherein the processor is arranged to detect whether wireless interface is available for live transmission to the server and to select information for transmission or buffering based on availability. In this way, the vehicle can operate robustly with an intermittent interface, contrary to some prior designs which go to great lengths to ensure a site will provide a reliable communication path. In the event the interface is unavailable, only higher priority data may be stored for subsequent transmission when the interface becomes available again.

An interface device typically will have a further memory for storing information separate from the buffer, wherein the processor is arranged to respond to a query received over the interface to transmit information stored in the further memory on request. The further memory may store detailed vehicle parameters and history and portions of it may be queried, either by reference to parameter labels or to memory addresses or both, or in response to a memory dump request. The parameters may be CANBUS parameters.

In some examples an operator communication interface arranged to store operator input received when the interface is not available for transmission at a time the wireless interface is available.

In this way, information may be returned to base without a need to be in direct communication at all times. The operator input may be active, for example an operator keying information into a terminal or keypad or passively collected, for example an operator presenting an authorisation token or taking an action may trigger an operator input signal without direct (other) intervention by the operator.

In some examples the wireless interface is a telecommunications interface having a data transmission protocol and a text message protocol wherein the apparatus is arranged to format data into messages suitable for transmission by the text message protocol in the event the data transmission protocol is unavailable.

Whereas a GPRS (or 3G) protocol is well known for GSM type modems, in some locations, it can be unreliable and less robust than an SMS protocol. According to this aspect of the invention, the interface may continue to operate (albeit at reduced data throughput) if only SMS communication is available. In conjunction with the prioritisation functions, a highly robust remote interface may be provided. In other applications, a Wifi 802.11 (b/g/n etc) communication link may be provided.

In one possibility the processor is arranged to communicate operator information bi-directionally with an operator console or operator application. Therefore, there is provided a server for communicating with a plurality of remote vehicles each having an interface device the server comprising vehicle data memory for storing vehicle information received from a plurality of vehicles and operator information memory for storing operator information received or messages for transmission to the operator. In some examples the server is arranged to make the vehicle data memory available to a first application and the operator information memory available to a second application.

In this way a maintenance application may access vehicle parameter records and may transmit queries for further remote diagnosis and a management or workflow planning or timekeeping application may communicate with the operator or make use of the operator data, over the same (robust) communication interface.

In the example of FIG. 1 enable logic 11 is configured to co-operate only with a particular vehicle having a particular secure enablement unit 8. Communication between enable logic and the secure enablement unit can be preceded by a secure handshake in which the enable logic provides the secure enablement unit 8 with a unique vehicle identifier and in the event that the unique vehicle identifier does not match a value stored in the secure enablement unit at least one operation of the vehicle is inhibited. Therefore if vehicle authorisation control unit 11 is swapped onto a different vehicle without authorisation (reprogramming of vehicle identity logic 4) then at least a part of vehicle functionality 10 will be disabled. In other embodiments, the vehicle identifier is read from the vehicle so the authorisation control unit can be swapped between vehicles without the need for reprogramming. In others the ID is stored programmably.

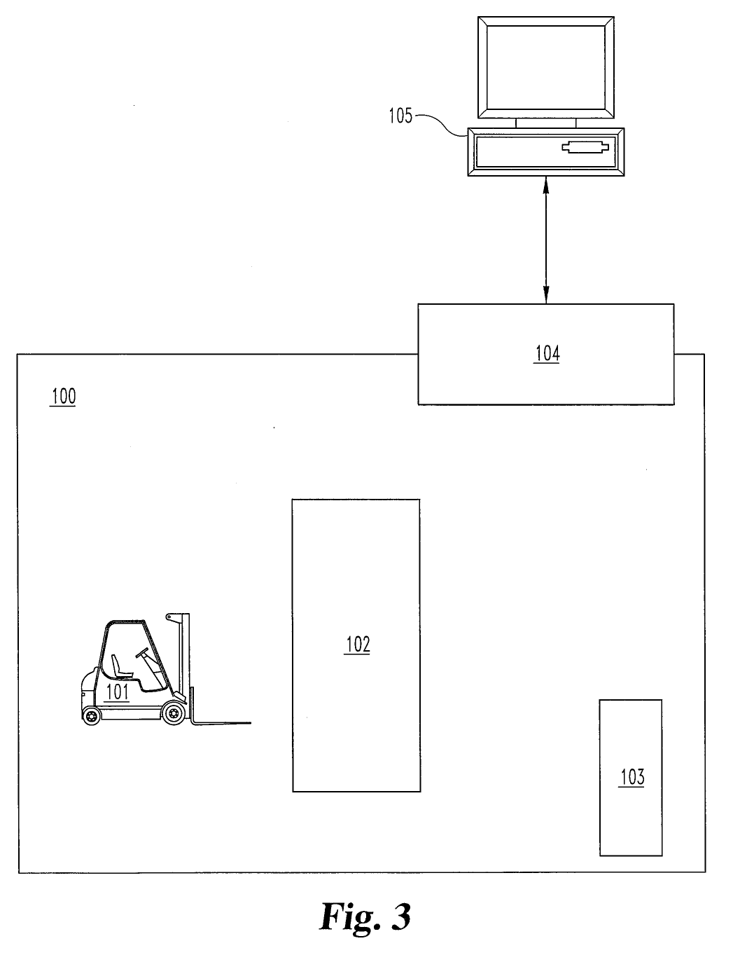

Driver record logic 6 comprises a non volatile memory and a read/write interface to permit data to be written to and read from the non volatile memory. Once an operator has been authorised to operate the vehicle the unique driver identifier is recorded and an event log, associated with that driver identifier is created and maintained. An event log typically includes time and date information, one or more event indications and particular operational parameters of the vehicle during operation by that driver. For example an event indication may be an accelerometer or tilt switch indication to provide a record that a vehicle has been tilted or has suffered an impact. Typically only events which exceed a threshold (for example a threshold acceleration/impact or a threshold tilt angle) are recorded, thereby the authorisation device is able to obtain and record a unique driver identifier or pass it on to other systems (e.g. remotely) for use for example in identifying an individual driver in the event of an incident. Incident reporting and monitoring is described below in greater detail with reference to FIG. 3.

Driver access token 1 comprises a memory 2 storing user interface information readable by vehicle authorisation control device 3. User interface information read from driver access token 1 is used to configure a user interface 12 of the vehicle. User interface 12 comprises controls 13 configurable by the user interface information to provide control of one or more operations of a vehicle. User interface information selectably configures controls 13 to control functions of vehicle 10 for example start and stop and in some embodiments may include directional movement controls, lift extent and reach of the truck. By controlling configuration of the user interface operating permissions of a user can be provided in a way that cannot be overridden by the user.

As described above, different vehicles have different capabilities and such vehicles may require different levels of training and/or authorisation in order to ensure safe and effective operation and to comply with regulatory standards, for example health and safety standards. In addition different users may be permitted to operate vehicles in different ways, for example certain users may be permitted only to operate vehicles carrying loads less than a selected limit and or to operate vehicles below a restricted speed or not to extend the manipulation arms (forks or straddle reach) of the vehicle beyond a given height or extent.

User interface information can configure controls 13 to provide operator access to selected features. For example a user who is a technician or vehicle engineer can be provided with an access token 1 configured with a technician attribute. On presenting such a token the technician is presented with user interface information to provide access to some or all of the diagnostic and/or maintenance functions of a vehicle. Normally there will be a limited number of “superusers” such as a supervisor or a technician. A supervisor has a supervisor attribute set (for example a binary identifier associated with the token) which may authorise the supervisor to drive any vehicle without requiring a vehicle identifier match and/or enable the supervisor to reset alarms or enable a vehicle after an incident in which operation of the vehicle has been disabled by the authorisation control unit. Certain vehicles may be more technically complex than others or require different maintenance training It is possible that certain maintenance tasks may require a technician attribute and/or a vehicle identifier match. Without a vehicle identifier match a technician may be authorised only to disable a vehicle to prevent use of the vehicle before maintenance is complete and to operate certain diagnostic functions of the vehicle. A technician with a vehicle identifier match may be authorised to carry out the full range of diagnostic and maintenance functions. As noted a user who is a supervisor may be authorised to operate all functions of a vehicle and to override certain time lock-out and alarm functions. As will be appreciated in the context of the particular examples provided, other examples of specific attributes giving “special” permissions based on user interface information may be employed. Example user interfaces include sets of buttons with corresponding visual indicators to indicate the function each button is configured to provide, alternatively or additionally a user interface includes a touch sensitive screen upon which a set or sets of menus and configurable soft keys can be provided to provide configurable user controls 13.

Information for configuring the user interface may be stored on the driver access token 1 and/or stored on the authorisation control device 3 and activated dependent on information stored on the token. Authorisation control unit 3 uses a high performance 16 bit microcontroller to run a configurable application to manage and report on the vehicle operators. The activity of the operator is logged for reporting to a control room. Typically communication interface 5 uses a MIFARE™ contact-less RFID card to store the user profile and access rights. Authorisation control unit 3 can be powered from an automotive power source (12 or 24V) and ideally is tested to ISO 7637 standards.

As described in more detail above, different operating modes can be selected and authorisation control unit 3 can shutdown the equipment in the event of an impact or excess idling. To provide this and additional functions a secure authorisation and control unit can be coupled to a vehicle control system such as a CANBUS to allow microcontrollers and devices to communicate with each other within vehicle 10 without a host computer. Preferably monitoring and control data read from the CANBUS is communicated to a remote device via the authorisation control device. Communicated information can include for example: service hours; current, minimum and maximum engine speed (rpm); current, minimum and maximum oil pressure; current, minimum and maximum water temperature; and other diagnostic parameters. Odometer information may also be provided including vehicle idle time, vehicle speed, fuel economy (instantaneous and running average values). In preferable embodiments a second CANBUS interface is provided.

Other parameters which may be usefully monitored include all basic instrumentation information, the machine serial number, traction and hydraulic hour meters, speed and battery voltage, motor and pump temperatures and fault codes. In one embodiment the power requirements of an authorisation control device are less than 5 Watts and the device may be operable over a voltage range of between 6 and 30 Volts DC.

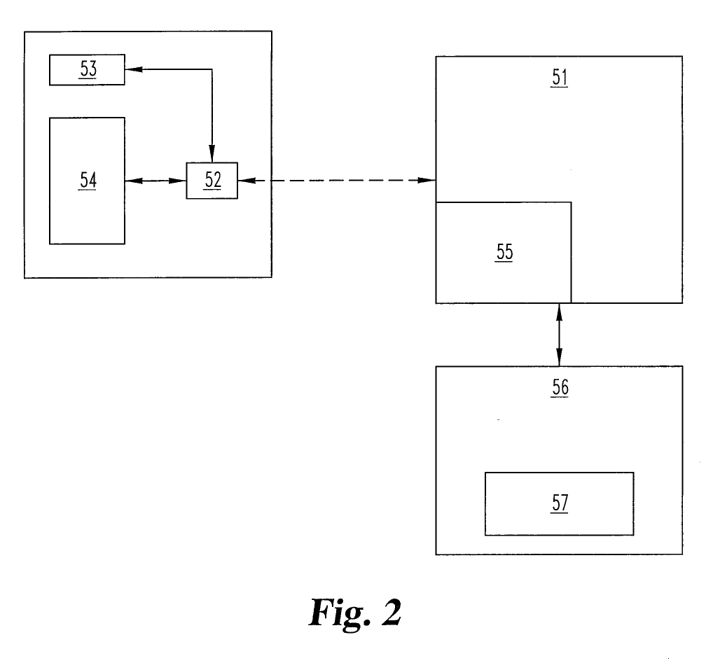

The example of FIG. 2 shows a driver access token 50 coupled to a driver access token update system 51. Removable rewritable driver token 50 has a communication interface 52 coupled to read and write data to a memory storing a unique driver identifier 53 and to read and write data to a memory storing a list of a plurality of authorised vehicle identifiers 54.

Driver access token update system 51 comprises a communication interface 55 for communicating with communication interface 52 of a driver access token. Update system 51 is coupled to a controller 56. Controller 56 typically provides processor functionality comparable to a personal computer and operates using facility access software 57. The token 50 is couplable to the update system 51 via communication interfaces 52 and 55 to communicate (i.e. read and write) data between memory held on the token and the update system. The token 50 is marked with visible text and/or a photo ID and may also store data for use by a facility access control and monitoring application for monitoring time and attendance and/or providing secured access to a building.

Driver access token update system 51 comprises an access point to which a driver may present a token, for example on “clocking on” for work and gaining access to the facility in which he is to work. The access point includes reader circuitry for reading the token to recognise a unique identifier of the token and writing logic for updating the list of authorised vehicles stored on the token. Each time a driver presents the token to an access point to gain access to the facility, the list of vehicles he is authorised to may be updated at that time. In this way no complex communication between a central controller and vehicles within the facility is required and a simple list of vehicle authorisations can be written to access card memory by taking advantage of a routine daily process and without the operator or supervisor needing to perform any additional tasks. To support this function a software platform is provided which contains a list of vehicle access permissions for each operator and one or more pieces of user interface information. This application maintains a list of functions an operator is permitted to use in the control, and/or maintenance and repair of vehicles and interfaces with infrastructure in a facility (such as a warehouse) to manage

A warehouse facility is illustrated in schematic form in FIG. 3 in which a warehouse facility 100 houses a mobile asset 101, a plurality of moveable stationary assets 102 and a wireless communication relay 103. Access to the facility is controlled by management system 104 (which includes features of the driver access token update system 51 described above with reference to FIG. 2). Management system 104 is in communication with user interface and control means 105.

Mobile asset 101 is configured to communicate wirelessly with management system 104 via communication relay 103. Mobile asset 101 carries an authorisation control device 3 as (described above with reference to FIG. 1) which stores information for communication with management system 104. Stored information is stored in a buffer local to the authorisation control device 3 and is communicated to the communication relay when a clear communication channel is available. Thereby, in the event that mobile asset 101 moves moveable stationary assets 102 in such a way that modifies the wireless communication environment or is simply out of radio contact, no immediate problem results as information is stored and can be transmitted when communication is re-established. This addresses the disadvantages of some prior art systems in which real-time information is required to be sent directly to a management system and provides a robust communication and management method in an unpredictable radio environment.

In an example event information is stored locally and only transmitted if impact or tilt information associated with an event exceeds a threshold as described above. This further improves the robustness of the system by reducing bandwidth demands on the communication. In addition, when an event is detected a technician or supervisor can review a comprehensive record of the vehicles operation without the need to transmit large volumes of information over a wireless link.

Management system 104 and/or user interface and control means 105 is configurable with software to report stock volumes and operator attendance information for stock monitoring and control. The software can be provided with an interface for modifying per vehicle permissions of an operator based on information held in other applications or systems, for example in personnel records. Advantageously sensitive asset control permissions can be controlled with reference to centrally held and verified personnel records, for example training certificates and other information.

Updates may be processed at separate times and simply updated at next presenting of the token. In one example a driver token may be provided as part of an ignition key or a key fob.

In some embodiments or aspects the invention provides methods of updating the memory of the token by providing an incremental update of the token memory, for example by overwriting a single memory entry, groups of memory entries or overwriting the entire memory. Similarly embodiments or aspects may provide methods of querying the memory of the token by providing a stepwise (sequential) query of the token memory, for example by reading a single memory entry, reading groups of memory entries or reading the entire memory.

To determine whether an operator is authorised for a particular vehicle communication interface 5 reads a list of a plurality of vehicle identifiers from a non volatile memory of a secure access token 1. Each vehicle identifier is compared with at least one stored vehicle identity attribute derived from the vehicle identifier logic.

Enable logic 8 (FIG. 1) can be configured to provide an authorisation signal based on a match between a vehicle identifier stored on a secure access token 1, 50 (FIGS. 1 and 2) without looking up a driver identifier. As described above, in a warehouse facility the secure authorisation unit 3 will typically have only an intermittent communication link to management system 104 105. Secure authorisation unit 3 (FIG. 1) permits an authorisation to be given without requiring a response from central computer in response to presenting a token programmed with correct permissions. To provide enhanced security and control functions while permitting flexible operation the secure authorisation unit is arranged to authorise vehicle in response to a match and to buffer driver ID and communicate it to central computer when a communication link become available, for example when a link with communication relay 103 provides at least a threshold quality of service or error rate.

In environments where the available communications bandwidth is limited, or to provide improved battery performance the authorisation control device 3 is arranged to communicate driver identification information following an incident or an event such as a detected impact. To provide similar advantages authorisation control device 3 is arranged to communicate driver identification information in response to a command received over a second communication interface and/or from central computer. When an event or incident such as an impact is detected at least part of vehicle functionality 9 may be disabled and require a reset authority before permitting the vehicle operation to continue.

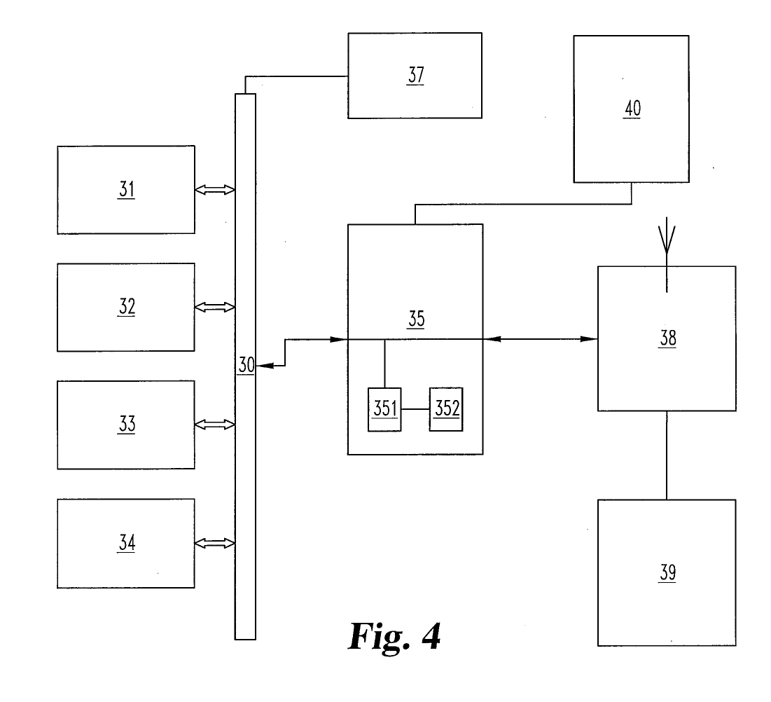

In FIG. 4 a schematic diagram of vehicle components includes a CANBUS vehicle bus 30 to allow microcontrollers and vehicle systems to communicate with each other, for control and monitoring functions within the vehicle. The CANBUS 30 is arranged for communication between hydraulic system 31, engine 32, speed and directional control systems 33 and battery control system 34 and other vehicle systems (not shown).

A control unit 35, such as an authorisation control unit, is coupled to a non volatile memory 40 and is arranged to read information from the CANBUS 30. Typically, control unit 35 comprises logic 351 coupled to a memory 352 storing programmable reporting thresholds (minimum or maximum levels) and/or ranges. An event indicator 36 is coupled to the control unit 35. FIFO CANBUS buffer is coupled to the CANBUS 30 and to control unit 35. A vehicle communications interface 38 is provided with communications buffer 39.

FIFO CANBUS buffer 37 provides a first-in-first-out buffer memory to record the status of the CANBUS over a period of time. Control unit 35 is configured to read the contents of the FIFO CANBUS buffer 37 into non volatile memory 40 in the event that event indicator 36 indicates that an event is detected. Control unit 35 may poll the event indicator periodically (or in round-robin fashion if more than one event indicator is present) or may be arranged to receive an interrupt signal transmitted by event indicator 36 to trigger the contents of the FIFO CANBUS buffer 37 to be dumped into non volatile memory 40.

Generally, to avoid clashes on the CANBUS, the FIFO CANBUS buffer is coupled to the CANBUS as a receive-only node (i.e. it does not transmit any messages on the BUS). As will be appreciated in the context of the present application, each node is typically able to send and receive messages, but not simultaneously. Generally a message includes an identifier to indicate the message-type and/or sender—and up to eight message bytes. Messages are transmitted serially onto the bus, one bit after another. The FIFO buffer is programmable to monitor CANBUS traffic relating only to particular devices or vehicle systems by filtering using the CANBUS identifier. To increase the period of time over which CANBUS data may be recorded by the FIFO buffer the FIFO buffer preferably is programmable via selection parameters to buffer only a subset of transmitted CANBUS information (i.e. CANBUS messages having particular device identifiers and/or message type). The selection parameters for this CANBUS message filter may be configured remotely, for example by a diagnostic engineer at a remote terminal in communication with the vehicle.

The use of a CANBUS buffer enables the state of the CANBUS before any given event to be known, it is not required to record all CANBUS information and it is not required to transmit CANBUS information in real time. In response to particular CANBUS events (CAN parameters exceeding certain programmable thresholds or ranges) or other events the contents of the buffer can be transmitted and/or dumped into a local non-volatile memory (such as a hard disk or flash memory). This enables the occurrence of events to be monitored without the need for real-time communication which is costly in terms of bandwidth

Information available for reading from the CANBUS bus 30 includes hydraulic pressure, oil pressure and temperature, lift time, move time, vehicle speed, brake operation, brake fluid levels and pressures, coolant temperature, battery charge levels and other vehicle information. As will be appreciated by the skilled practitioner the foregoing list is illustrative only and in any particular case fewer or more parameters may be available to be read from the CANBUS.

During usual operation of the vehicle control logic 30 is arranged to read information from the CANBUS and to compare information with one or more programmable reporting thresholds or ranges. A threshold or range may be programmed for any or all information which is available to be read from the CANBUS.

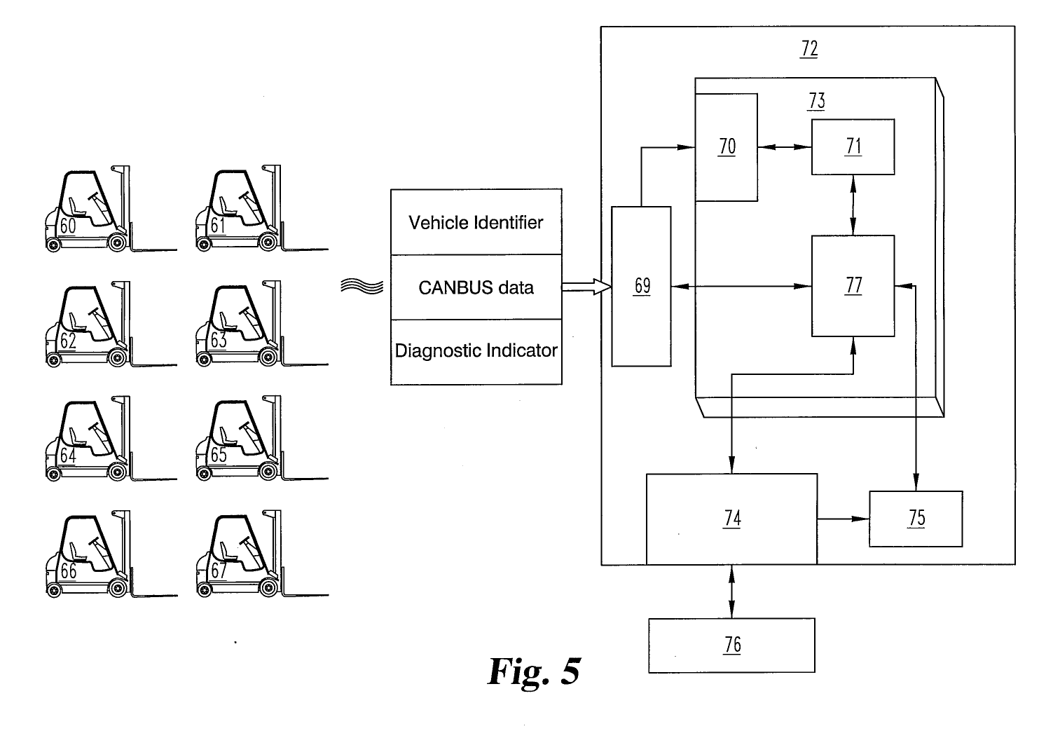

On the basis of a comparison between CAN information and one or more thresholds and/or ranges (as described above) control unit logic 351 may determine to report and/or record current CAN information using communication interface 38. Communications buffer 39 provides local storage of communication information. Buffered communication information can be transmitted directly, buffered temporarily before transmission, stored in non-volatile memory 40 and transmitted subsequently, for example in the event that the communication buffer 40 overflows. This technique enables transmission to take place when transmission conditions are favourable or when a request is transmitted by a facility control station (for example a system such as that described below with reference to FIG. 5). By this method the need for real time communication can be entirely avoided thereby increasing transmitter battery life, reducing bandwidth requirements (for example by transmitting information when higher bandwidth is available) and enabling vehicle operation and diagnostic information to be monitored in a manner that is robust and reliable.

Communications interface 38 may be a discrete unit or it may be integrated into other vehicle functionality or provided by or included in an authorisation control unit substantially as described herein with reference to FIG. 3.

An event indicator 36 may include an alarm button, an accelerometer, a tilt switch, a gyroscope and/or a location determiner (such as GPS or a robust local location determining system such as the RFID grid described herein below)

Asset performance monitoring is performed based on CAN information and other event indicators collected in each asset using the systems described. Associated with each vehicle is a performance score which is calculated based on vehicle parameters. Systems in a vehicle may be subdivided between critical systems and performance support systems. For example an asset may still operate safely and effectively, albeit sub-optimally with a lower than ideal tire pressure or slightly reduced oil levels or hydraulic pressure. Such parameters are referred to herein as non-critical parameters (i.e. those not mandated by safety requirements or operating needs of an asset) and may be given integer values between 1 and 100 to indicate a percentage score. Certain other parameters, for example oil temperature, fuel level, battery level and coolant levels may be considered critical parameters. In other words, if these values are not within a given range safe and/or effective functioning of the vehicle is prevented. Within certain ranges critical parameters may be considered non critical and may be assigned a score which contributes to the overall performance score of the vehicle. An overall performance score can be assigned for example as P, where

$$P = {\prod }_{i = 1}^{N} {X}_{i} {\sum }_{j = 1}^{M} {Y}_{j} \qquad ( 1 )$$

In equation 1 above Xᵢ indicate critical parameters, which are binary indicators. If any critical parameter is zero the overall system score is zero and the asset is considered non-functioning. Each term Yⱼ indicates a score associated with a non-critical parameter, as will be appreciated certain parameters which are critical parameters outside certain ranges may be considered critical if they go beyond permitted ranges. Therefore the same vehicle system may contribute to the overall performance score P as both a critical and non critical parameter. Other methods of calculating a performance score will be apparent to the skilled practitioner in the context of the present application and any appropriate method may be chosen dependent on the particular constraints of a given situation. Whatever performance scoring system is used each vehicle is associated with an indication which can be used to assess when (i.e. how soon) maintenance actions may be required or for how long such actions can be postponed. Preferably the indication is accompanied by at least some diagnostic reporting information such as selected CANBUS information, impact or tilt indications and/or fault codes.

The diagram of FIG. 5 shows a plurality of mobile assets 60, 61, 62, 63, 64, 65, 66, 67, 68 each of which comprise a communication interface for wireless communication 69 with a local communication interface of a facility control system 72. The facility control system comprises a controller 73 coupled to communicate with one or more of the mobile assets via local communication interface 69 and to communicate with remote station 76 via wide area communication interface 76. The facility control system 72 comprises a non-volatile memory 75 coupled to controller 73. Controller 73 comprises control logic 77, vehicle diagnostics logic 70 and correlator 71. Controller 73 is arranged to communicate with local communication interface 69 to monitor received vehicle information (for example vehicle information transmitted by a system substantially as described with reference to FIG. 4) and to transmit vehicle control and information messages via wireless communication 68.

A first vehicle 63 is arranged to communicate vehicle information with local area communication interface 69, the vehicle information comprising vehicle identifier information, CANBUS data and a diagnostic or event indicator such as a fault code. Based on CANBUS data, diagnostic or event indicator information a performance score can be calculated for each vehicle. Dependent on the particular constraints of each application the performance score may be calculated in each vehicle and transmitted to facility control system 72 or required information can be collated centrally so that a score can be assigned. Alternatively a mixture of these two approaches can be employed.

In general operation a vehicle will communicate information with the facility control system on a periodic or intermittent basis so that the vehicle status can be tracked. Real-time information is not communicated to avoid placing an undue burden on the communications network. Periodic or intermittent updates can be sent or event driven updates may be or buffered/recorded as described above in response to performance score changes or other events.

Correlator 71 maintains a table of vehicle status information comprising a plurality of vehicle status entries including performance scores. In this example each vehicle status entry is determined by vehicle diagnostics logic 70. Vehicle diagnostics logic and correlator 71 co-operate to determine a likely maintenance schedule for each vehicle based on at least one of a performance score or a performance indicator.

Vehicle components may have a finite predictable life which depends, inter alia, on factors including mileage, engine RPM, oil pressure and temperature and other engine parameters. Where appropriate the time integral and/or the average of these parameters may be used to predict the lifetime of components by reference to manufacturer's data sheets or historical data obtained from asset locations.

On the basis of a diagnostic indicator or an event indicator control logic 77 determines whether the received information relates to a routine maintenance status update or to an event indication.

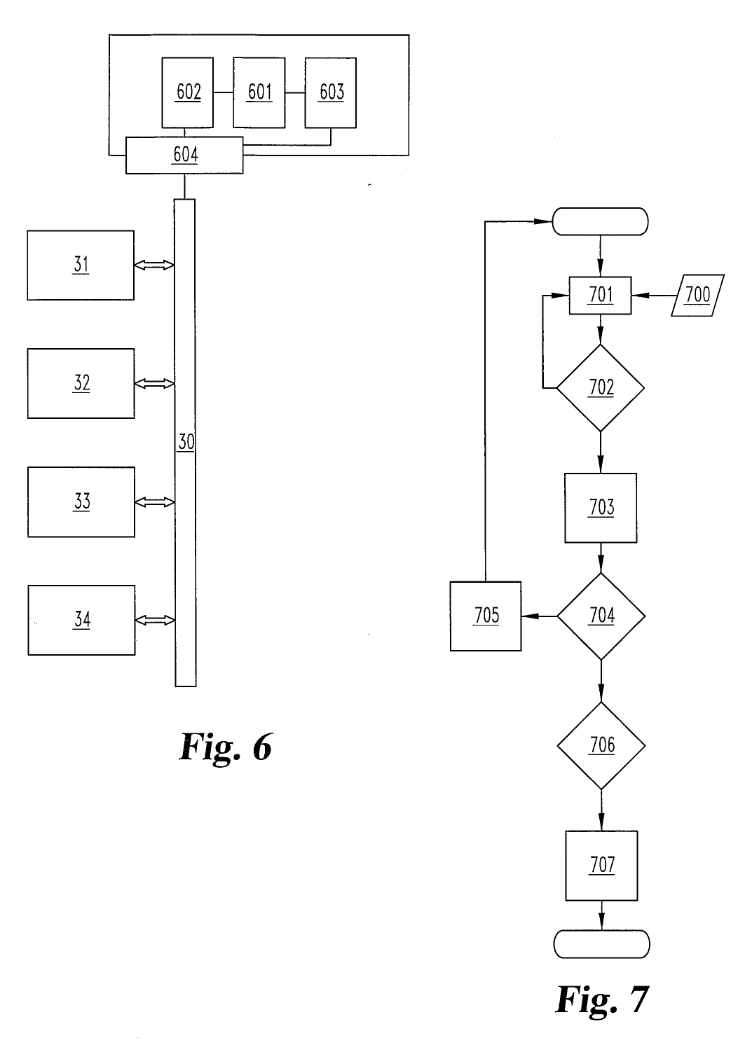

In the example of FIG. 6 an diagram of a programmable vehicle power controller is shown comprising a timer 601 and a vehicle idling sensor 602 coupled to the timer and to the CANBUS 30 of the vehicle (not shown) to sense whether the vehicle is idling. CANBUS 30 is coupled to communicate CAN messages with a plurality of vehicle systems 31, 32, 33, 34.

A switch arrangement (shutdown controller) 603 is coupled to the timer 601 and is arranged to shut down a power supply in the vehicle in response to the timer indicating that a time interval has elapsed. The vehicle power controller 600 is provided with a communication interface 604 to receive commands and/or other information. The programmable vehicle power controller 600 is programmable to set the time interval based on one or more received commands and/or other information, such as CAN messages.

For connection to the CANBUS, communication interface 604 comprises a host-processor to parse received messages to determine their type ID and their content and to transmit messages on to the CANBUS. Further sensors, actuators and other control devices can be connected to the host-processor. The communication interface further comprises a synchronous clock to control the rate at which, the interface 604 reads bits (one by one) from the bus. Messages for transmission onto the BUS are stored by the host-processor and the bits transmitted serially onto the bus. As will be appreciated, signal level regulation and other adapters are applied to provide suitable voltage transmission onto the BUS and to protect electronics from overvoltage conditions. On a BUS of a length typically found in a vehicle (20 metres or less) bit rates up to of up to 1 Mbit/s are provided. The CAN protocol standard is described in greater detail in ISO 11898-1 (2003) the entirety of which is incorporated herein by reference.

In FIG. 6 the switch arrangement 603 is provided by an interface to the CAN operable to send an “engine off” message to the ignition system or other power control system of the engine. In this example the communication interface 604 includes the CAN interface and can further include a wireless communication system such as a wifi interface, GSM GPRS, UMTS or other wireless interface.

The flow chart of FIG. 7 provides a schematic representation of operation of a vehicle power controller in which an idling indicator 700 is received by the controller at 701 which determines 702 whether the engine is idling. In the event that the engine is idle the timer is started 703. If, at 704, it is determined that the engine has ceased to be idle then the timer is reset 705. In the event that the engine remains idle until the time limit is determined at 706 to have expired a control signal is provided, for example using switch arrangement 603, to switch off the engine.

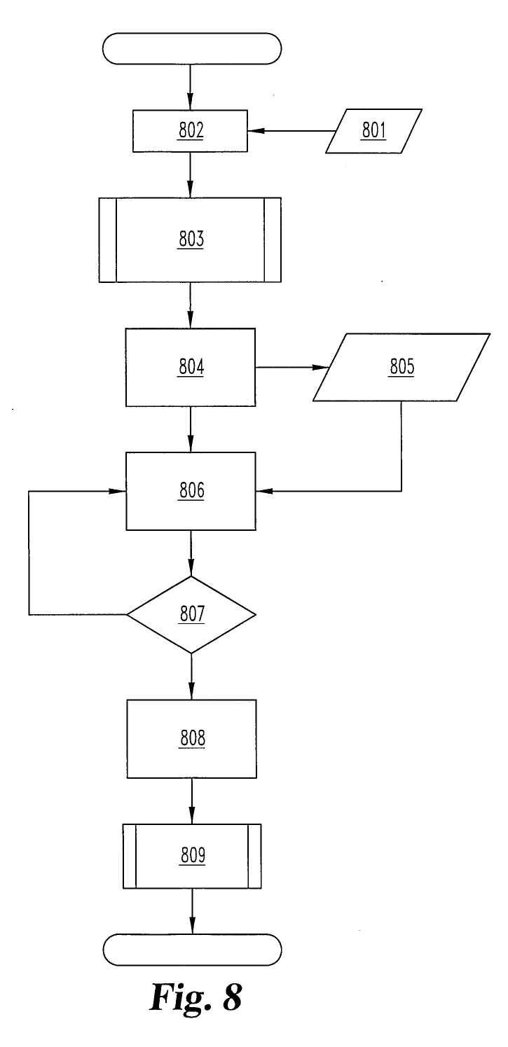

The flow chart of FIG. 8 shows a representation of a method of configuring the time interval such as for use in a controller according to FIG. 6. A command 801 provides configuration information which is received at 802 and processed at 803 to determine criteria for modification of the time interval dependent on CAN message information. In response to the process output, based on the received command the vehicle power controller is configured at 804 to monitor the CANBUS for CAN messages associated with a particular vehicle system (for example having a particular type identifier 805) such as a fuel gauge reading and/or a battery level reading. One or more CAN message type identifiers are written into a memory and, at 806 messages associated with that CAN message identifier are read from the CANBUS to derive device information associated with that type identifier. In the event that a message of the identified type is received the message is parsed and, in the event that it is determined that the time interval needs to be updated the timer is updated accordingly and monitoring of idle time is then performed according to the process described above with reference to FIG. 7.

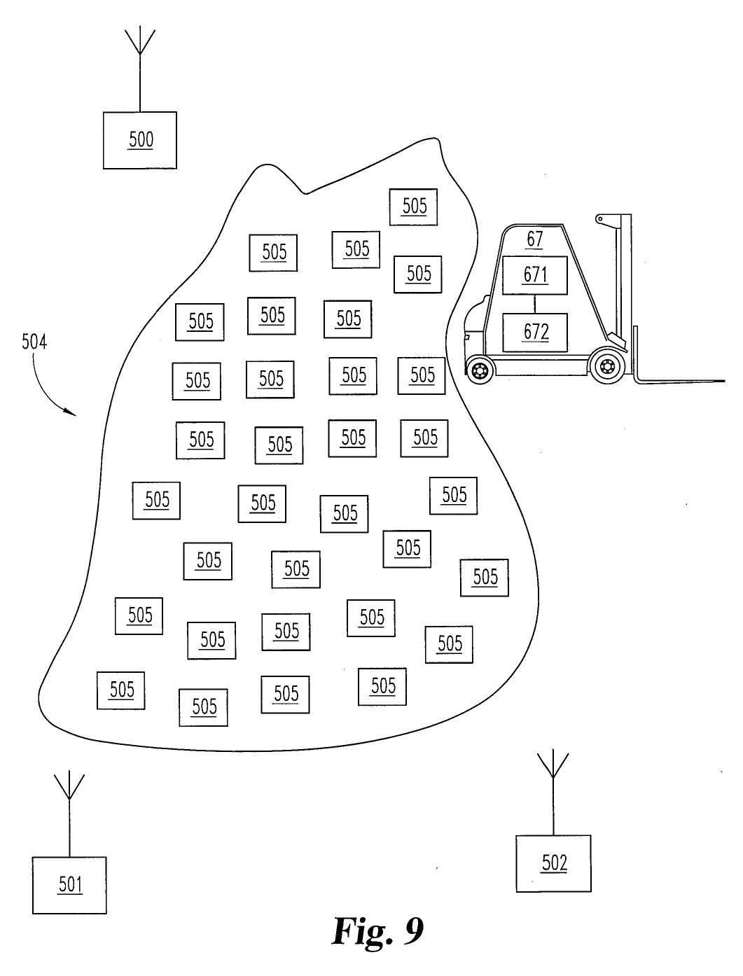

FIG. 9 shows a facility 504 in which a plurality of passive RFID tags 505 is distributed at fixed locations. Disposed about the facility, at known reference locations are at least three reference communicators 500, 501, 502. A mobile device 67 in wireless communication with reference communicators comprises an RFID reader for reading the plurality of RFID tags and a memory 671 coupled to the reader.

In a calibration step the mobile asset traverses the facility 504 while triangulating its position between the at least three reference communicators 500, 501, 502 via wireless communication. As the facility is traversed each RFID tag is read and the tag data is stored in the memory 671 along with triangulated position information. Thereby a stored association is created between each tag (or each of a plurality of sets of tags) and triangulated location information. Clearly, triangulation is not required, GPS information could be used for this triangulation step. In certain facilities (for example underground facilities or facilities with heavy/dense/radio opaque superstructures) GPS signals are not available or are of insufficient quality to provide sufficiently accurate location information.

Logic functions and determining and aggregation steps described herein may be implemented by programming computing apparatus, for example a personal computer. Typically computing apparatus has a processor associated with memory (ROM and/or RAM), a mass storage device such as a hard disk drive, a removable medium drive (RMD) for receiving a removable medium (RM) such as a floppy disk, CDROM, DVD or the like, input and output (I/O) control units for interfacing with the components of the monitoring facility of FIG. 5 to enable the processor to control operation of these components. The user interface consists, for example, of a keyboard, a pointing device, a display such as a CRT or LCD display and a printer. The computing apparatus may also include a communications interface such as a modem or network card that enables the computing apparatus to communicate with other computing apparatus over a network such as a local area network (LAN), wide area network (WAN), an Intranet or the Internet. The processor may be programmed to provide the logic features of the examples described herein by any one or more of the following ways: 1) by pre-installing program instructions and any associated data in a non-volatile portion of the memory or on the mass storage device; 2) by downloading program instructions and any associated data from a removable medium received within the removable medium drive; 3) by downloading program instructions and any associated data as a signal supplied from another computing apparatus via the communications interface; and 4) by user input via the user interface.

The features of methods and devices set out herein relate to systems which can be used in conjunction with one another and are intended to be so combined where appropriate.

Such combinations are examples from which it will be apparent that the features of any example, aspect or embodiment described herein may be combined with some or all of the features of any other embodiment aspect or example. In addition certain terminology used throughout the description should not be construed as limiting, for example where reference is made to a vehicle or a truck this may be any mobile asset having the required features and functionality. Equivalently sensors and detectors may be referred to interchangeably as indicated by the context of the description. It is apparent that many modifications and variations of the present invention are possible in light of the above teachings. References to specific values or standards are by way of example only. It is therefore to be understood that, within the scope of the appended claims the invention may be practised otherwise than as specifically described.

While the preferred embodiment of the invention has been illustrated and described in the drawings and foregoing description, the same is to be considered as illustrative and not restrictive in character, it being understood that all changes and modifications that come within the spirit of the invention are desired to be protected.

1. A monitoring station comprising:
a communication interface for communication with a plurality of monitoring devices each device arranged to monitor an operational parameter of a mobile asset; and,
a processor coupled to the communication interface to receive a first operational parameter associated with a first asset and a second operational parameter associated with a second asset;
wherein the processor is configured to determine a maintenance requirement of the first asset based on the first operational parameter; and to select a maintenance action for the second asset based on the maintenance requirement of the first asset and the second operational parameter.

2. A monitoring station according to claim 1 comprising a memory for storing a list of identifiers, each identifier associated with a monitoring device and wherein each identifier indicates a type of asset.

3. A monitoring station according to claim 1 wherein selecting a maintenance action for the second asset comprises scheduling a maintenance action based on the maintenance requirement of the first asset and the geographical proximity of the first and second assets.

4. A monitoring station according to claim 1 having a memory for storing a spare parts inventory and wherein the processor is arranged to read the spare parts inventory and to select a maintenance action for the second asset based on an availability of spare parts.

5. A monitoring station according to claim 4 wherein the processor is arranged to indicate a requirement for additional spare parts in response to determining a maintenance requirement.

6. A method of scheduling maintenance of a plurality of assets at a respective asset location, the method comprising:
receiving respective asset operational parameters from the plurality of assets at a remote monitoring system; receiving respective asset identifiers, obtaining position information and determining a likely maintenance requirement for at least one asset based on the operational parameters; and
scheduling maintenance actions for one of the plurality of assets based on a maintenance requirement of at least one other asset of the plurality of assets and the position information.

7. A method according to claim 6 wherein a likely maintenance requirement includes a repair of an asset.

8. A method according to claim 6 wherein a likely maintenance requirement includes preventative maintenance of an asset.

9. A method according to claim 6 wherein a likely maintenance requirement includes preventive maintenance of an asset to prevent a predicted component failure.

10. A method according to claim 6 wherein an asset is a warehouse vehicle and wherein the respective asset location is a warehouse.

11. A method according to claim 6 wherein the operational parameters are received via a wireless communication link and wherein position information is obtained by inferring position information from a property of the communication link.

12. A method according to claim 11 wherein the property of the communication link comprises at least one of: an IP address, a GSM number, an email address and wherein inferring includes making a comparison with stored location information associated with that communication link.

13. A method according to claim 6 in which position information is derived from a positioning system comprising:
a plurality of machine readable identifiers arranged in predetermined positions about the asset location and a memory storing an association between one or more positions in the facility and one or more of the plurality of identifiers and a proximity reader carried on the respective asset for reading a machine readable identifier of the plurality of identifiers to enable a processor to derive position information based on the stored association.

14. A method according to claim 6 wherein the operational parameters comprise CANBUS information derived from a CANBUS of the warehouse vehicle, wherein CANBUS information includes at least one of hydraulic pressure, oil pressure and temperature, lift time, move time, vehicle speed, brake operation, brake fluid levels and pressures, coolant temperature, and battery charge levels.

15. A monitoring and reporting device for use in a mobile asset comprising:
a measurement interface for measuring operational parameters of a mobile asset and a buffer coupled to the measurement interface for storing measured operational parameters;
and
a communication interface for receiving commands from a remote monitoring system and a processor configured to store measured operational parameters in the buffer in response to a received command.

16. A monitoring device according to claim 15 wherein the measurement interface includes a CANBUS interface.

17. A monitoring device according to claim 16 wherein operational parameters include parameters derived from a CANBUS message and wherein the processor is configurable by a remote command to store selected CANBUS messages, wherein CANBUS messages are selected based on a message type identifier.

18. A monitoring device according to claim 15 wherein the processor is configured to one of: transmit the contents of the buffer using the communication interface when the amount of data stored in the buffer exceeds a threshold level; and to determine whether the communication interface is able to communicate with a remote monitoring station.

19. A monitoring device according to claim 16 wherein the processor is configured to communicate with the remote monitoring station in response to determining that the device is in a predetermined location based on position information derived from a positioning system comprising:
a plurality of machine readable identifiers arranged in predetermined positions about the asset location and a memory storing an association between one or more positions in the facility and one or more of the plurality of identifiers; and
a proximity reader carried on the respective asset for reading a machine readable identifier of the plurality of identifiers to enable a processor to derive position information based on the stored association.

20. A monitoring device according to claim 18 wherein the processor is configured to at least one of: store data from the buffer into a non-volatile memory in the event that it is determined that the communication interface is not able to communicate with a remote monitoring station; test periodically whether the communication interface is able to communicate with a remote monitoring station; test whether the communication interface is able to communicate with a remote monitoring station in response to actuation of a user actuable switch coupled to the processor; and transmit stored data in the event that it is determined that the communication interface is able to communicate with a remote monitoring station.
